(19) United States
(12) Patent Application Publication
(10) Pub. No.: US 2024/0103606 A1
(43) Pub. Date: Mar. 28, 2024

(54) SYSTEMS AND METHODS FOR OBJECT INTERACTIONS

(71) Applicant: HES IP HOLDINGS, LLC, Austin, TX (US)

(72) Inventors: Yung-Chin HSIAO, Taipei City (TW); Ya-Chun CHOU, Taipei City (TW); Shan-Ni HSIEH, Tainan City (TW); Chun-Hung CHO, Taipei City (TW); Te-Jen KUNG, Hsinchu City (TW); I-Chun YEH, Taoyuan City (TW)

(73) Assignee: HES IP HOLDINGS, LLC, Austin, TX (US)

(21) Appl. No.: 18/260,927

(22) PCT Filed: Jan. 25, 2022
(86) PCT No.: PCT/US2022/013771

§ 371 Date: Jul. 10, 2023

Related U.S. Application Data
(60) Provisional application No. 63/140,961, filed on Jan. 25, 2021.

(51) Int. Cl. G06F 3/01; G06T 7/20; G06T 7/50; G06T 7/60; G06T 7/73; G06T 19/00; G06V 20/20; G06V 40/10

(52) U.S. Cl. CPC G06F 3/011; G06T 7/20; G06T 7/50; G06T 7/60; G06T 7/73; G06T 19/00; G06V 20/20; G06V 40/11; G06T 2207/10024; G06T 2207/10028; G06T 2207/30196; G06T 2210/21

(57) ABSTRACT

The present disclosure relates to systems and methods for real and virtual object interactions in augmented reality environments are disclosed. The system comprises areal object detection module to receive multiple image pixels and the corresponding depths of at least one initiative object, a real object recognition module to determine a shape, a position, and a movement of the initiative object; a virtual object display module to display a virtual target object, a collision module to determine whether the at least one initiative object collides into a virtual target object and, an interaction module for determining an action responding to an event based on at least one of an object recognition determination from the real object recognition module, a collision determination from the collision module, and a type of the virtual target object.

### RELATED APPLICATION

This application claims the benefit of the provisional application 63/140,961 filed on Jan. 25, 2021, titled “SYSTEM AND METHOD FOR VIRTUAL AND REAL OBJECT INTERACTIONS IN AUGMENTED REALITY AND VIRTUAL REALITY ENVIRONMENT,” which is incorporated herein by reference at its entirety.

In addition, the PCT international application PCT/US20/59317, filed on Nov. 6, 2020, titled “SYSTEM AND METHOD FOR DISPLAYING AN OBJECT WITH DEPTHS” is incorporated herein by reference at its entirety.

### BACKGROUND OF THE INVENTION

### Field of the Invention

The present invention relates to object interactions; more particularly, to systems and methods for interactions between at least one initiative object and a real/virtual target object in augmented reality environments.

### Description of Related Art

Augmented reality technology allows real objects to coexist with virtual objects in the augmented reality environments; meanwhile, it also provides users with applications which they can interact with virtual objects. In conventional augmented realty or virtual reality environments, motion capture of users or target objects may need to rely on markers or sensors worn by the users or the target objects. The motion related data captured by these markers or sensors are then transferred to a physical engine to realize interactions between the users or the target objects (virtual objects). However, wearing markers or sensors may be inconvenient for the users and creates drawbacks to the users' experience. Furthermore, some conventional augmented realty or virtual reality environments implement large numbers of cameras for positioning the real objects to enable the interactions between real and virtual objects. Consequently, there is a need for providing a novel approach to enhance experience of real and virtual object interactions.

### SUMMARY

The present disclosure relates to systems and methods for object interaction between at least one initiative object and a target object. In one embodiment, the first initiative object and the second initiative object may respectively be a right hand and a left hand of a user. The target object may be a real target object, such as an electronic appliance, or a virtual target object, such as a virtual baseball, a virtual dice, a virtual car, and a virtual user interface. The interactions between the target object and the initiative object can be categorized based on various interaction factors, such as shape, position, and movement of the at least one of the first initiative object and the second initiative object.

The inventive system for object interactions comprises a real object detection module, a real object recognition module, a virtual object display module, a collision module, and an interaction module. The real object detection module is to receive multiple image pixels and the corresponding depths of at least one of a first initiative object and a second initiative object. The real object recognition module is to determine a shape, a position, and a movement of the at least one of the first initiative object and the second initiative object. The virtual object display module is to display a virtual target object at a first depth by projecting multiple right light signals towards one retina of a user and corresponding multiple left light signals towards the other retina of the user. The collision module is to determine whether at least one of the first initiative object and the second initiative object collides into a virtual target object. The interaction module is to determine an action responding to an event based on at least one of an object recognition determination from the real object recognition module, a collision determination from the collision module, and a type of the virtual target object.

In one embodiment, if the first initiative object is a right hand and the second initiative object is a left hand, the real object recognition module determines the shape of at least one of the right hand and the left hand by determining whether each finger is respectively curved or straight. In another embodiment, the collision module generates an outer surface simulation for at least one of the right hand and the left hand.

In one embodiment, the real object recognition module determines the movement of at least one of the first initiative object and the second initiative object by changes of the shape and the position of at least one of the first initiative object and the second object during a predetermined time period. The collision module determines a collision type by a number of contacts, the collision region of each contact, and the collision time of each contact. The virtual target object may be one of at least two types comprising a movable target object and a fixed target object.

In one embodiment, when the virtual target object is a fixed virtual user interface and the collision determination is that a collision occurs, the interaction module determines the action responding to an event based on a description of the user interface object. The description may be a predetermined function to be performed such as opening or closing a window or an application. When the virtual target object is a movable target object, the collision determination is “pushing,” and the object recognition determination is that the movement of a pushing hand has a speed faster than a predetermined speed, the interaction module determines an action of moving the virtual target object, and the virtual object display module displays the virtual target object in the reacting movement. When the collision determination is “holding,” if the number of contacts is two or more, the at least two collision regions are fingertips, and the collision time is longer than a predetermined time period.

In another embodiment, the real object recognition module determines the position of at least one of the right hand and the left hand by identifying at least 17 feature points respectively for the hand and obtaining a 3D coordinate for each feature point. In another embodiment, the real object recognition module determines the shape of at least one of the right hand and the left hand by determining whether each finger is respectively curved or straight.

### BRIEF DESCRIPTION OF THE DRAWINGS

FIG. 1 is a block diagram illustrating an embodiment of a systems for object interactions in accordance with the present invention.

FIGS. 2A-2B are schematic diagrams illustrating the relationship between the RGB image and depth map.

FIG. 3 is a schematic diagram illustrating each of the 21 feature points of a human hand in accordance with the present invention.

FIGS. 4A-4C are schematic diagrams illustrating criteria of determining whether a finger is straight or curved.

FIGS. 5A-5C are schematic diagrams illustrating different shapes of a hand in accordance with the present invention.

FIGS. 6A-6C are schematic diagrams illustrating embodiments of generating outer surface simulation of a hand by applying geometrical modeling technology in accordance with the present invention.

FIG. 7 is a diagram illustrating various types of target objects in accordance with the present invention.

FIG. 8 is a schematic diagram illustrating an embodiment of object interaction between a hand and a virtual object in accordance with the present invention.

FIGS. 9A-9D are schematic diagrams illustrating another embodiment of object interaction between a hand of a user and a real target object and a virtual target object in accordance with the present invention.

FIG. 10 is a schematic diagram illustrating an embodiment of a head wearable system in accordance with the present invention.

FIG. 11 is a schematic diagram illustrating an embodiment of multi-user interactions in accordance with the present invention.

FIG. 12 is a schematic diagram illustrating the light path from a light signal generator to a combiner, and to a retina of a viewer in accordance with the present invention.

FIG. 13 is another schematic diagram illustrating the light path from a light signal generator to a combiner, and to a retina of a viewer in accordance with the present invention.

FIG. 14 is a schematic diagram illustrating the relationship between depth perception and a look up table in accordance with the present invention.

FIG. 15 is a table illustrating an embodiment of a look up table in accordance with the present invention.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The present disclosure relates to systems and methods for object interaction between at least one of a first initiative object and a second initiative object (each one is referred to as an initiative object), and a target object. Based on an interaction between the at least one of the first initiative object and the second initiative object, and the target object, an action would be determined. In one embodiment, the first initiative object and the second initiative object may respectively be a right hand and a left hand of a user. The target object may be a real target object, such as an electronic appliance, or a virtual target object, such as a virtual baseball, a virtual dice, a virtual car, a virtual user interface. The interaction between the at least one of the first initiative object and the second initiative object, and the target object is an event that triggers specific actions, such as tapping a virtual control menu to increase a volume of an electronic appliance and throwing a virtual baseball towards a virtual home base to display a motion of the virtual baseball. Such interaction is categorized based on various interaction factors, such as shape, position, and movement of the at least one of the first initiative object and the second initiative object; if the initiative object has a collision with the target object, a number of contacts, contact regions, duration of contacts; and the spatial relationship between the initiative object and the target object.

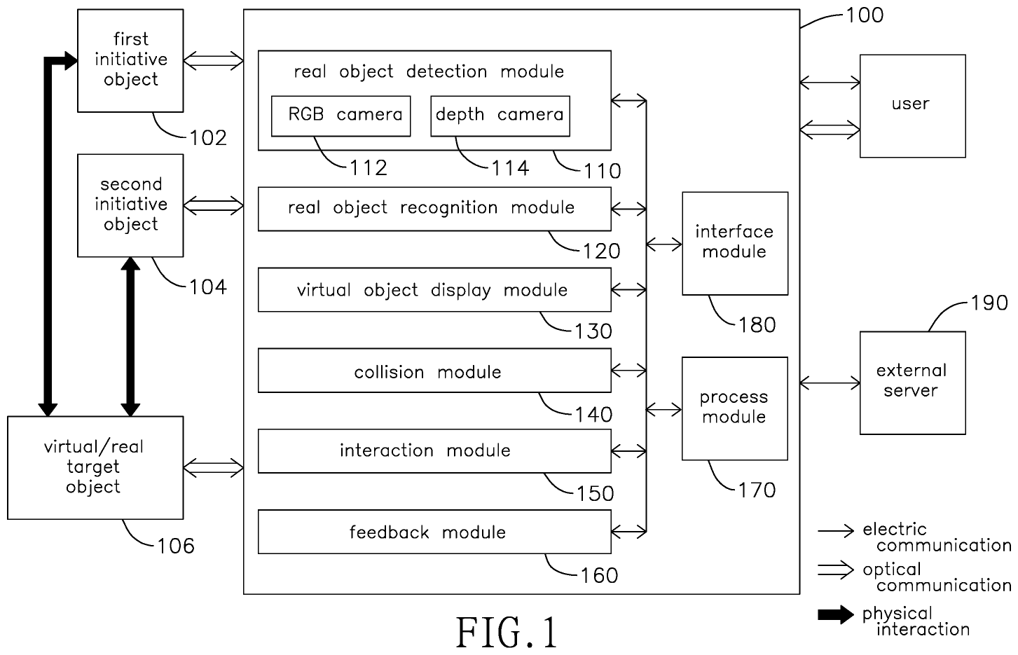

As shown in FIG. 1, the inventive system 100 for object interactions comprises a real object detection module 110, a real object recognition module 120, a virtual target object display module 130, a collision module 140, and an interaction module 150. The real object detection module 110 is to receive multiple image pixels and the corresponding depths of at least one of a first initiative object 102 and a second initiative object 104. The real object recognition module 120 is to determine a shape, a position, and a movement of the at least one of the first initiative object 102 and the second initiative object 104. The virtual target object display module 130 is to display a virtual target object 106 at a first depth by projecting multiple right light signals towards one retina of a user and multiple left light signals towards the other retina of the user, wherein the first depth is related to a first angle between the right light signal and the corresponding left light signal projected into the user's retinas. The collision module 140 is to determine whether at least one of the first initiative object 102 and the second initiative object 104 collides into a virtual target object 106 and, if a collision occurs, a collision region, and a collision time and duration. The interaction module 150 is to determine an action responding to an event based on at least one of an object recognition determination from the real object recognition module 120, a collision determination from the collision module 140, and a type of the virtual target object 106.

The real object detection module 110, in one embodiment, may include a positioning component to receive both multiple image pixels and the corresponding depths of at least one of a first initiative object 102 and a second initiative object 104. In another embodiment, the real object detection module 110 may include at least one RGB camera to receive multiple image pixels of at least one of a first initiative object 102 and a second initiative object 104, and at least one depth camera to receive the corresponding depths. The depth camera 114 may measure the depths of initiative objects and target object in surroundings. The depth camera 114 may be a time-of-flight camera (ToF camera) that employs time-of-flight techniques to resolve distance between the camera and an object for each point of the image, by measuring the round-trip time of an artificial light signal provided by a laser or an LED, such as LiDAR. A ToF camera may measure distance ranging from a few centimeters up to several kilometers. Other devices, such as structured light module, ultrasonic module or IR module, may also function as a depth camera used to detect depths of objects in surroundings. When the target object 106 is real target object, the real object detection module 110 may be configured to receive multiple image pixels and the corresponding depths of the real target object as well.

The real object recognition module 120 may determine a shape, a position, and a movement of the at least one of the first initiative object 102 and the second initiative object 104 from the information received by the real object detection module 110. The real object recognition module may include processors, such as CPU, GPU, AI (artificial intelligence) processors, and memories, such as SRAM, DRAM and flash memories, to calculate and determine the shape, the position, and the movement of the at least one of the first initiative object 102 and the second initiative object 104. In order to determine the shape of the initiative object, the real object recognition module 120 may have to first identify multiple feature points of the initiative object and then determine the 3D coordinates of these feature points. The system 100 needs to establish an inertia reference frame to provide a 3D coordinate for each point of the physical world. In one embodiment, the 3D coordinate of each point represents three directions-a horizontal direction, a vertical direction, and a depth direction, such as XYZ coordinate. When the system 100 is a head wearable device to be used in a virtual reality (VR), augmented reality (AR), and mixed reality (MR) environment, a horizontal direction (or X axis direction) may be set to be along the direction of interpupillary line. A vertical direction (or Y axis direction) may be set to be along the facial midline and perpendicular to the horizontal direction. A depth direction (or Z axis direction) may be set to be right to the frontal plane and perpendicular to both the horizontal and vertical directions.

In order to provide an inertia reference frame, the system 100 may further comprise a position module 116 (not shown) which may determine a user's position and direction both indoors and outdoors. The position module 116 may be implemented by the following components and technologies: GPS, gyroscope, accelerometers, mobile phone network, WiFi, ultra-wideband (UWB), Bluetooth, other wireless networks, beacons for indoor and outdoor positioning. The position module 116 may include an integrated inertial measurement unit (IMU), an electronic device that measures and reports a body's specific force, angular rate, and sometimes the orientation of the body, using a combination of accelerometers, gyroscopes, and sometimes magnetometers. A user using the system 100 comprising a position module 116 may share his/her position information with other users via various wired and/or wireless communication manners. This function may facilitate a user to locate another user remotely. The system may also use the user's location from the position module 116 to retrieve information about surroundings of the location, such as maps and nearby stores, restaurants, gas stations, banks, churches etc.

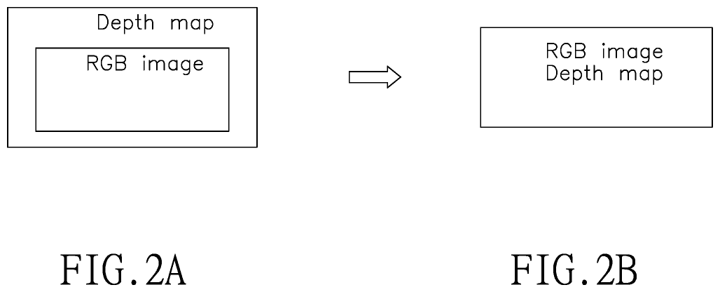

The multiple image pixels provide a 2D coordinate, such as XY coordinate, for each feature point of the initiative object. However, such a 2D coordinate is not accurate because the depth is not taken into consideration. Thus, as shown in FIGS. 2A-2B, the real object recognition module 120 may align or overlay the RGB image comprising the multiple image pixels and the depth map so that the feature point in the RGB image superimpose onto the corresponding feature point on the depth map. The depth of each feature point is then obtained. The RGB image and the depth map may have different resolutions and sizes. Thus, in an embodiment as shown in FIG. 2B, the peripheral portion of the depth map which does not overlay with the RGB image may be cropped. The depth of a feature point is used to calibrate the XY coordinate from the RBG image to derive the real XY coordinate. For example, a feature point has an XY coordinate (a, c) in the RGB image and a z coordinate (depth) from the depth map. The real XY coordinate would be (a+b×depth, c+d×depth) where b and d are calibration parameters. Accordingly, the real object recognition module 120 employs the multiple image pixels and their corresponding depths captured at the same time to adjust horizontal coordinates and vertical coordinates respectively for at least one of the right hand and the left hand.

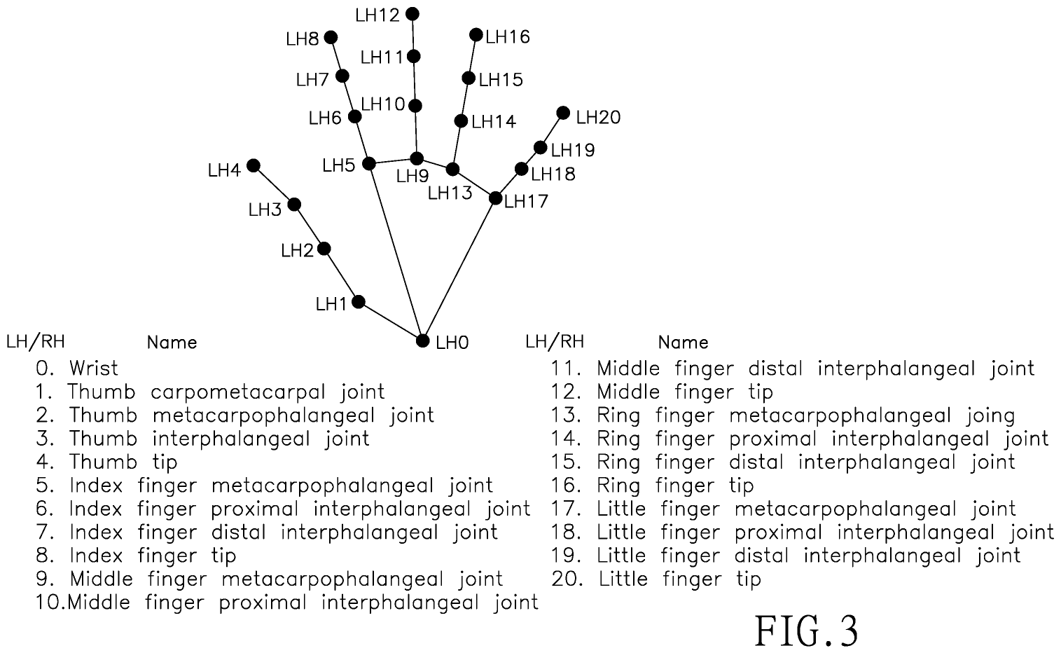

As described above, the first initiative object and the second initiative object may respectively be a right hand and a left hand of a user of the system 100. In order to recognize the shape of either the right hand or the left hand, the real object recognition module 120 identifies at least 17 feature points respectively for at least one of the right hand and the left hand. In one embodiment as shown in FIG. 3, each hand has 21 feature points-wrist and five fingers each of which has four feature points. Each hand has 5 fingers, namely thumb, index finger, middle finger, ring finger, and little finger. Each finger has four feature points, three joints (carpometacarpal joint (first joint), metacarpophalangeal joint (second joint), and interphalangeal joint for thumb (third joint) for thumb, and metacarpophalangeal joint (first joint), proximal interphalangeal joint (second joint), and distal interphalangeal joint (third joint) for the other four fingers) and one finger tip. The right hand has 21 feature points, namely RH0 (wrist), RH1 (thumb carpometacarpal joint), RH2 (thumb metacarpophalangeal joint) . . . RH19 (little finger distal inter phalangeal joint), and RH20 (little finger tip). Similarly, the left hand. has 21 feature points, namely LH0 (wrist), LH1 (thumb carpometacarpal joint), LH2 (thumb metacarpophalangeal joint) . . . LH19 (little finger distal inter phalangeal joint), and LH20 (little finger tip).

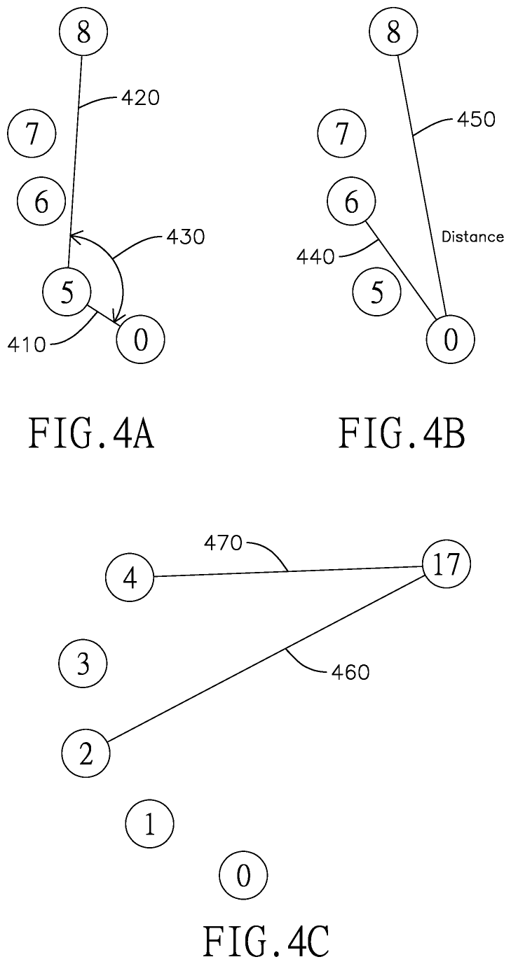

The shape of each hand may be represented by a spatial relationship of the 21 feature points. One perspective to categorize the shapes of a hand is to determine the status of each finger to be straight or curved. Thus, in one embodiment, the real object recognition module 120 determines the shape of at least one of the right hand and the left hand by determining whether each finger is respectively curved or straight. Accordingly, each hand may have 32 shapes because each hand has five fingers each of which has two possible statuses—curved and straight. Whether a finger is curved or straight may be determined by either or both of a finger angle 430 and a finger length difference (length of 450−length of 440). As shown in FIG. 4A, the finger angle 430 is the angle between a first line 410 formed by the wrist feature point, e.g. RH0, and the first joint of the finger, e.g. RH1, RH 5, RH9, RH13, and RH17 and a second line 420 formed by the first joint of the finger and the finger tip of the finger, e.g. RH4, RH8, RH12, RH16, and RH20. As shown in FIG. 4B, for index finger, middle finger, ring finger, and little finger, the finger length difference is the difference between a first length 450 measured from the waist, e.g. RH0, to the second joint of the finger, e.g. RH6, RH10, RH14, RH18 and a second length 440 measured from the waist and the fingertip of the finger, e.g. RH8, RH12, RH16, RH20. For thumb, the finger length difference is the difference between a third length 470 measured from the fingertip of thumb, e.g. RH4, to the first joint of the little finger, e.g. RH17, and a fourth length 460 measured from the second joint of thumb to first joint of the little finger. In one embodiment, a finger is determined to be straight when both the finger angle 430 is larger than 120 degrees and the finger length difference is larger than 0.

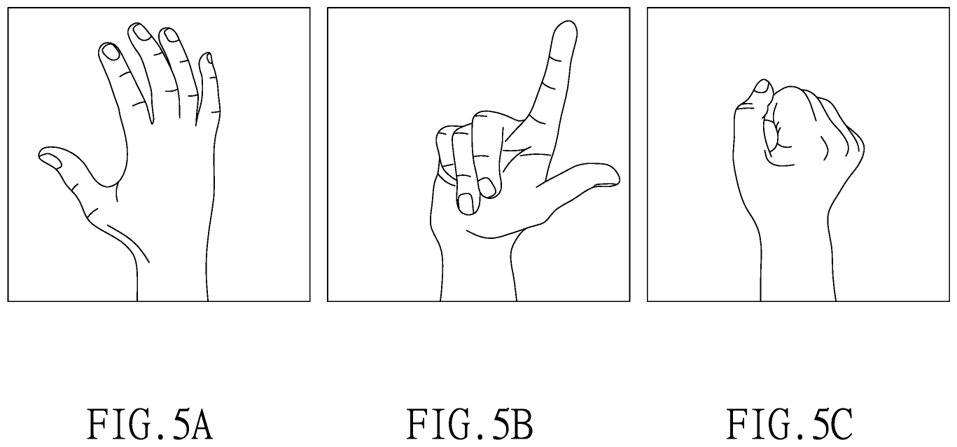

After the real object recognition module determines each of the fingers of a hand is straight or curved, by assigning 0 to represent a curved finger and 1 to represent a straight finger, each of the 32 shapes of a hand may be represented by a 5-binary-digit number with each digit sequentially showing the status of each finger from thumb to little finger. For example, 01000 represents a hand shape with a curved thumb, a straight index finger, a curved middle finger, a curved ring finger, and a curved little finger. This is probably one of the most used shape of a hand for a user to interact with a virtual user interface. In addition, FIGS. 5A-5C illustrate three shapes of a right hand. For example, FIG. 5A may be represented by 11111; FIG. 5B may be represented by 11000; and FIG. 5C may be represented by 00000.

After determining the shape and position of the initiative object at a specific time, the real object recognition module 120 continues to determine a movement of the initiative object by changes of the shape and the position during a predetermined time period. A movement may be a rotational motion, a translational motion, an oscillatory motion, an irregular motion, or a combination of any of the above-mentioned motions. A movement may have a direction, a speed, and an acceleration which may be derived from changes of the shape and position of the initiative object. Common types of movements may include pulling, pushing, throwing, rotating, and sliding. For example, the real object recognition module 120 may continue to analyze the changes of shapes and positions of the initiative object approximately 10 times a second and make a determination approximately every two seconds. The real object recognition module 120 generates an object recognition determination which may include object recognition related information, such as the shape, position, movement (including direction, speed, and acceleration), of the at least one of the first initiative object and the second initiative object, as well as the spatial relationship between the first and/or second initiative object and the target object.

The virtual target object display module 130 is configured to display a virtual target object 106 at a first depth by respectively projecting multiple right light signals towards one retina of a user and multiple left light signals towards the other retina of the user. In addition, a first right light signal and a corresponding first left light signal are perceived by the user to display a first virtual binocular pixel of the virtual target object so that the user perceives a binocular pixel at the first depth which is related to a first angle between the right light signal and the corresponding left light signal projected into the user's retinas. The virtual target object display module 130 includes a right light signal generator 10, a right combiner 20, a left light signal generator 30, and a left combiner 40. The right light signal generator 10 generates multiple right light signals which are redirected by a right combiner 20 to project into the user's first eye to form a right image. The left light signal generator 30 generates multiple left light signals which are redirected by a left combiner 40 to project into the user's second eye to form a left image.

The collision module 140 is configured to determine whether at least one of the first initiative object 102 and the second initiative object 104 collides into a virtual target object 106 and, if a collision occurs, a collision region, and a collision time and duration. The collide module 140 may generate an outer surface simulation for at least one of the first initiative object 102 and the second initiative object 104. As described before, the first initiative object and the second initiative object may respectively be the right hand and the left hand of the user. In one embodiment, the collision module 140 generates an outer surface simulation for both the right hand and the left hand of the user by scanning the outer surface of the right hand and the left hand. Thus, the simulation may instantly adjust the position (3D coordinate) of its outer surface by the shape of the hand and the position of 21 feature points of the hand. The simultaneous localization and mapping (SLAM) technology may be used to construct or adjust the outer surface of a hand and its spatial relationship with the environment. In another embodiment, the collision module 140 employs geometrical modeling technologies to generate an outer surface simulation of the right hand and the left hand. One geometrical modeling technology is referred to as volumetric hierarchical approximate convex decomposition (V-HACD) which decomposes the outer surface into a cluster of 2D or 3D convex components or a combination of 2D and 3D convex components. The 2D convex components may have geometric shapes such as triangles, rectangles, ellipses, and circles . . . etc. The 3D convex components may have geometric shapes such as cylinders, spheres, pyramids, prisms, cuboids, cubes, solid triangles, cones, domes . . . etc. Each convex component may then be assigned with a set of 2D or 3D coordinates/parameters to represent the special positions of the convex geometric shape for the simulation of its outer surface.

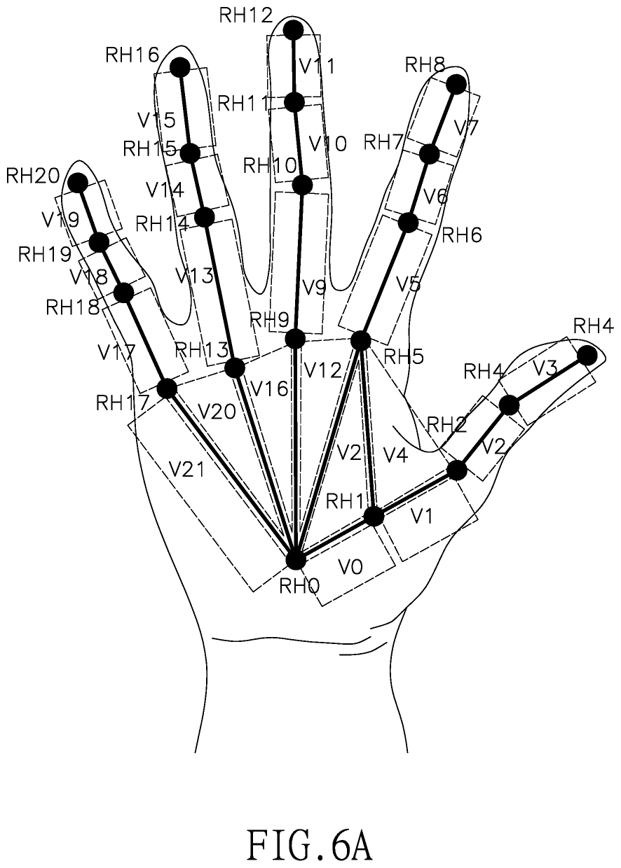

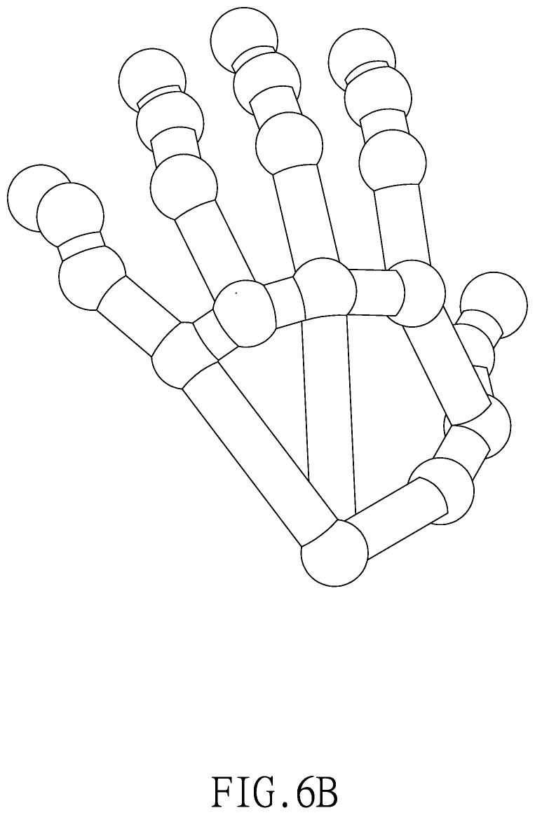

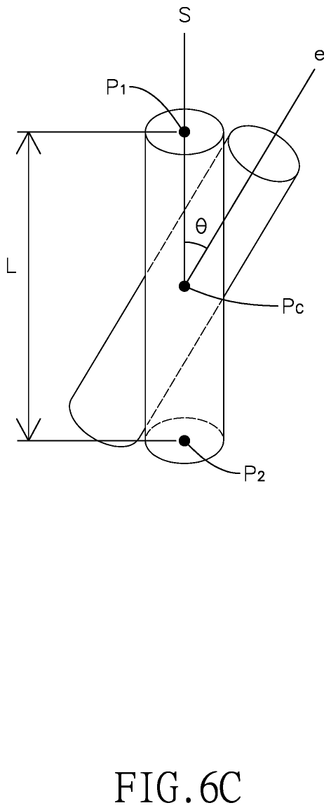

As shown in FIG. 6A, the outer surface simulation of a right hand is an assembly of twenty-two (22) 3D convex components from V0 to V21 whose geometrical shapes may be cylinders, cuboids, and solid triangles. Each finger comprises three convex components in cylinder shape. The palm comprises seven convex components. FIG. 6B illustrates another embodiment of an outer surface simulation of a hand by geometric modeling. Each of the 21 feature points of a left hand is represented by a 3D convex component in sphere shape. These feature points are connected by a 3D convex component in cylinder shape. The palm may be represented by multiple 3D convex components in the shape of solid triangles, prisms or cuboids. As shown in FIG. 6C, a 3D convex component in cylinder shape may be assigned several parameters, such as a 3D coordinate of the center point Pc, an upper radius, a lower radius, a length of the cylinder, and a rotational angle, to simulate its outer surface. These parameters may be obtained by a calibration process of a user's right hand and left hand. In the calibration process, geometrical information of each hand, such as palm thickness, distance between two knuckles (joints), finger length, opening angle between two fingers, etc. is collected and used to generate the outer surface simulation of a hand.

After generating the outer surface simulation for at least one of the first initiative object and the second initiative object, the collision module 140 determines whether there is a contact between the outer surface simulation for at least one of the first initiative object and the second initiative object, and an outer surface of the virtual target object. As described before, in one embodiment, the first initiative object and the second initiative object may be respectively the right hand and the left hand of the user. In the scenario that the target object 106 is a virtual target object displayed by the virtual target object display module 130, the outer surface of the virtual target object may be obtained from the system 100. In general, there is a contact between the outer surface simulation for the right hand or the left hand and the outer surface of the virtual target object, if the outer surface simulation for the right hand or the left hand intersects with the outer surface of the virtual target object. The extent of intersection may be measured by a volume of intersected space. However, to facilitate an interaction between the initiative object and the virtual target object, the collision module may determine that there is a contact if a smallest distance between the outer surface simulation for at least one of the right hand and an outer surface of the virtual target object is less than a predetermined distance, which for example may be 0.4 cm. As a result, even a hand has not actually contacted the virtual target object, since the hand is already very closed to the virtual target object, a contact may be determined to occur.

The collision module 140 generates a collision determination which may include various collision related information, such as whether there is a collision and if yes, a number of contacts (single-contact collision or multi-contact collision), a contact region of each contact, a collision time of each contact (starting time, ending time, and duration of a contact). A collision event may be categorized into various different types based on the collision related information. For example, single-contact collision, multiple-contact collision, holding (continuous multi-contact collision), single-tapping collision (one single-contact collision within a predetermined time period), double-tapping collision (two single-contact collisions within a predetermined time period), and sliding-contact or scrolling collision (one continuous single-contact collision with a moving contact region.

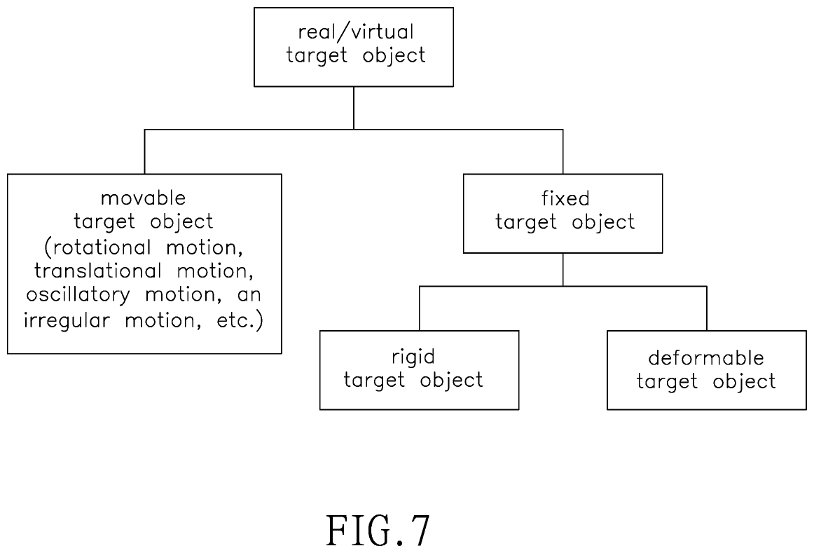

As described above, the target object may be a virtual target object or a real target object. As shown in FIG. 7, each real or virtual target object may be further categorized to a movable target object and a fixed target object based on whether the position (3D coordinate) of the target object is movable in light of the inertia reference frame. A movable virtual target object may be a virtual baseball, a virtual cup, a virtual dice, a virtual car. A fixed virtual target object may be a virtual user interface such as an icon, a button, a menu. The fixed target object may be further categorized to a rigid target object and a deformable target object based on whether an internal portion of the object is movable in relation to other portions of the object. A deformable target object may be a spring, a balloon, and a button that can be turned or pushed down.

The interaction module 150 is configured to determine whether an event occurs and a responding action if an event occurs. The object recognition determination from the real object recognition module 120 and the collision determination from the collision module 140 may be combined to define or categorize various types of events. The type and feature of the target object is also considered to determine the responding action to an event.

The collision determination is “pushing” if the number of contact is one or more, and the collision time is shorter than a predetermined time period. When the virtual target object is a movable target object, the collision determination is “pushing,” and the object recognition determination is that the movement of a pushing hand has a speed faster than a predetermined speed, the interaction module determines a reacting movement for the virtual target object, and the virtual object display module displays the virtual target object in the reacting movement.

The collision determination is “holding,” if the number of contacts is two or more, the at least two collision regions are fingertips, and the collision time is longer than a predetermined time period. When the virtual target object is a movable target object, the collision determination is “holding,” and the object recognition determination is that the movement of a holding hand has a speed slower than a predetermined speed, the interaction module determines a reacting movement for the virtual target object, which corresponds to the movement of the holding hand, and the virtual object display module displays the virtual target object in the reacting movement.

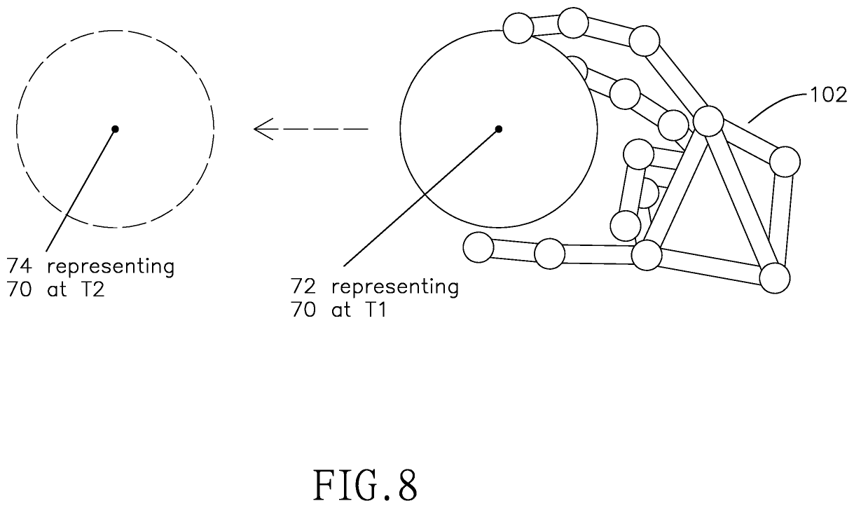

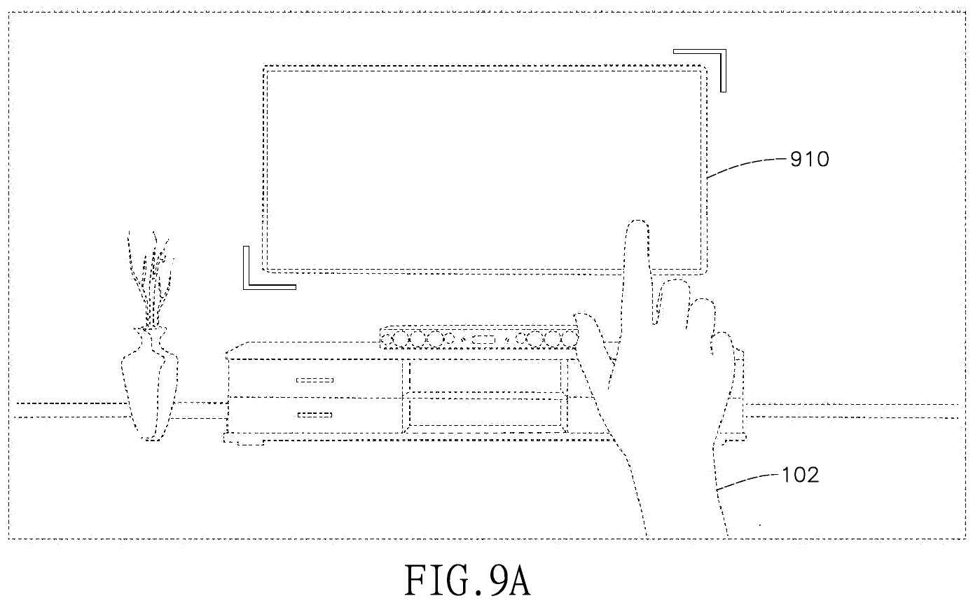

As shown in FIG. 8, the first event is that a user's right hand holds a virtual baseball (target object) and then the second event is that the user's right hand throws the virtual baseball 70 forward. Since the target object is a virtual baseball, the responding action to the first event is that the virtual baseball 70 remained held and moved along with the user's right hand. The responding action to the second event is that the virtual baseball 70 moves from a first targeted position T1 to a second targeted position T2. The baseball virtual target object 70 is displayed by the virtual target object display module at the first targeted position T1 (with depth D1) represented by a first virtual binocular pixel 72 (its center point) and when the baseball virtual target object 70 moves to a second targeted position T2 (with depth D2), it is represented by the second virtual binocular pixel 74.

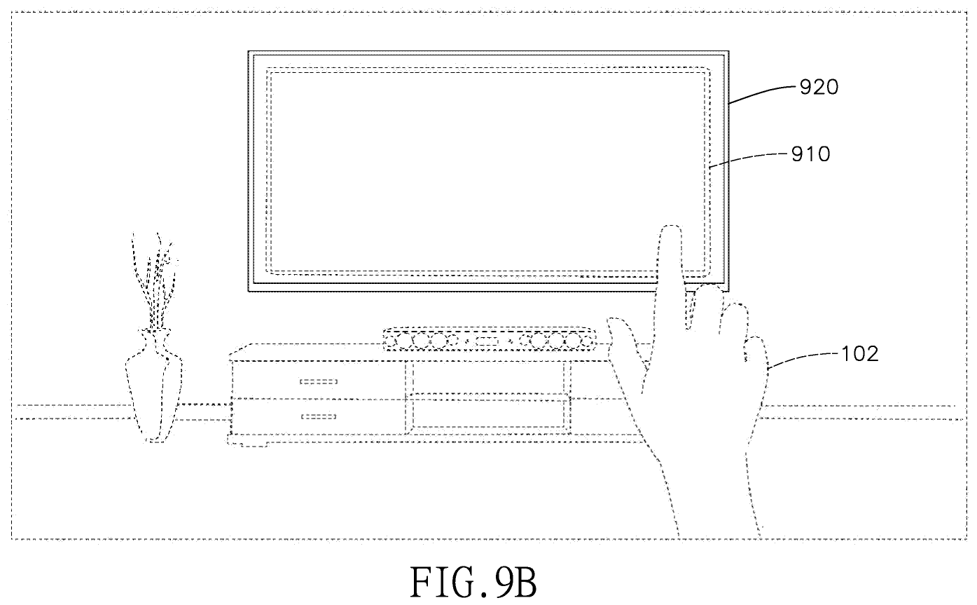

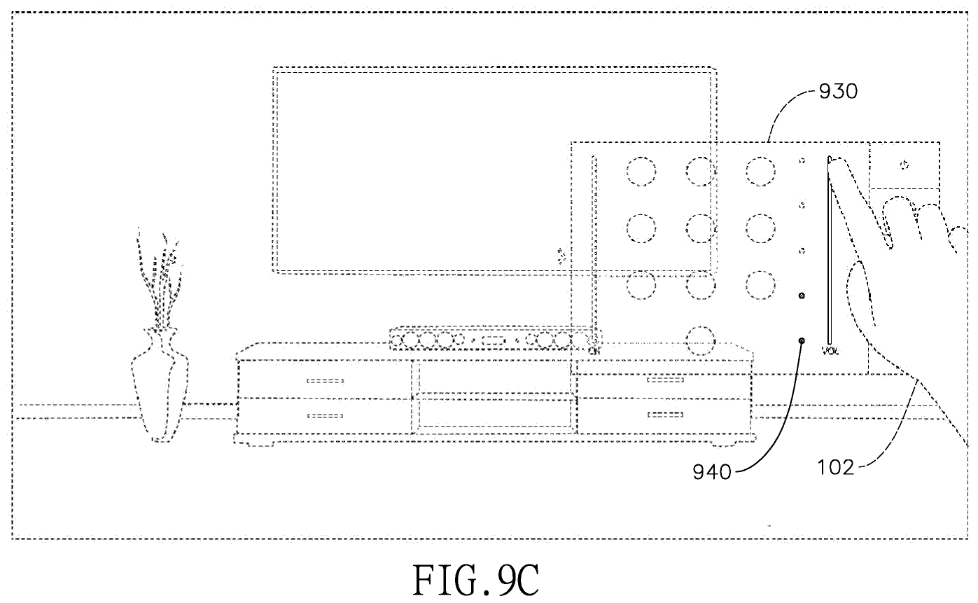

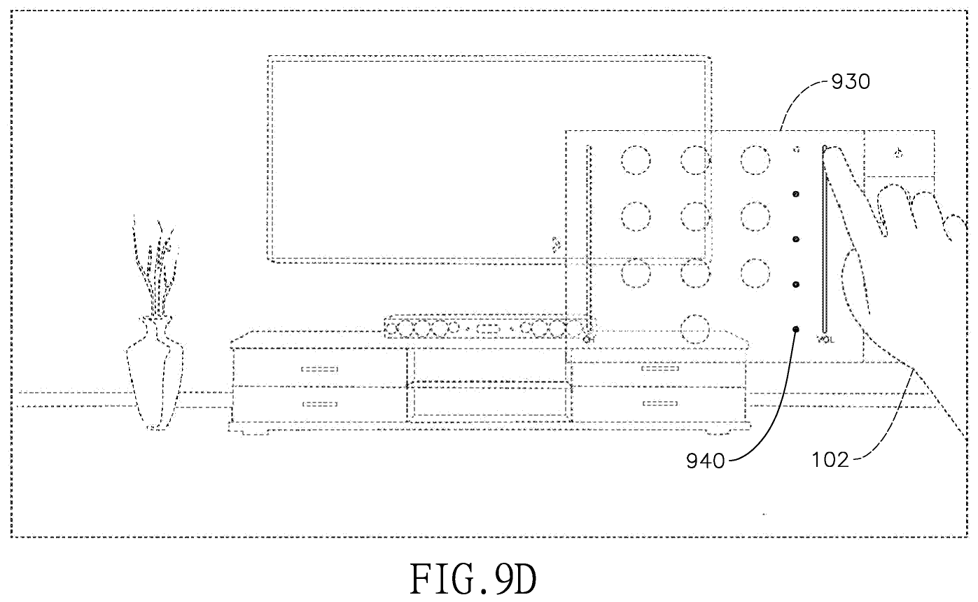

FIGS. 9A-9D illustrate that a user uses his/her right hand 102 with index finger pointing at a TV 910 (without touching) to initiate a virtual menu operation and then his/her index finger to contact a virtual volume bar 930 to adjust the volume. As shown in FIG. 9A, the first event is that a user's right hand with an index finger pointing shape (01000) points at a TV, a real target object without collision for a predetermined time period, for example 5 seconds. This event is determined by the shape of the right hand 102, the direction of the index finger, and the predetermined time period. As shown in FIG. 9B, the responding action is displaying a virtual rectangle 920 surrounding the TV 910 to notify the user that the TV 910 is selected and a virtual control menu 930 is popped up for further operation. As shown in FIG. 9C, only two out of five volume-indication-circles 940 are lighted. The second event is that the user's right hand 102 contacts the upper side of the virtual volume bar 930 for a period of time—a continuous single-contact collision with a virtual volume bar, a fixed virtual target object. As shown in FIG. 9D, the responding action is that four out of five volume-indication-circles 940 are lighted.

After the interaction module 150 recognizes an event and determines a responding action, it will communicate with other modules in the system, such as the virtual target object display module 130 and a feedback module 160, or with external devices/appliances, such as a TV and an external server 190, through an interface module 180 via wired or wireless communication channels, to execute the responding action.

The system 100 may further comprise a feedback module 160. The feedback module 160 provides feedbacks, such as sounds and vibrations, to the user if a predetermined condition is satisfied. The feedback module 160 may include a speaker to provide sounds to confirm that an initiative object contacts a virtual target object, and/or a vibration generator to provide various types of vibrations. These types of feedback may be set up by the user through an interface module 180.

The system 100 may further comprise a process module 170 for intensive computation. Any other module of the system 100 may use the process module to perform intensive computation, such as simulation, artificial intelligence algorithms, geometrical modeling, right light signals and left light signals for displaying a virtual target object. In fact, all computational jobs may be performed by the process module 170.

The system 100 may further comprise an interface module 180 which allows the user to control various functions of the system 100. The interface module 180 may be operated by voices, hand gestures, finger/foot movements and in the form of a pedal, a keyboard, a mouse, a knob, a switch, a stylus, a button, a stick, a touch screen, etc.

All components in the system may be used exclusively by a module or shared by two or more modules to perform the required functions. In addition, two or more modules described in this specification may be implemented by one physical module. For example, although the real object recognition module 120, the collision module 140, and the interaction module 150 are separated by their functions, they may be implemented by one physical module. One module described in this specification may be implemented by two or more separate modules. An external server 190 is not part of the system 100 but can provide extra computation power for more complicated calculations. Each of these modules described above and the external server 190 may communicate with one another via wired or wireless manner. The wireless manner may include WiFi, bluetooth, near field communication (NFC), internet, telecommunication, radio frequency (RF), etc.

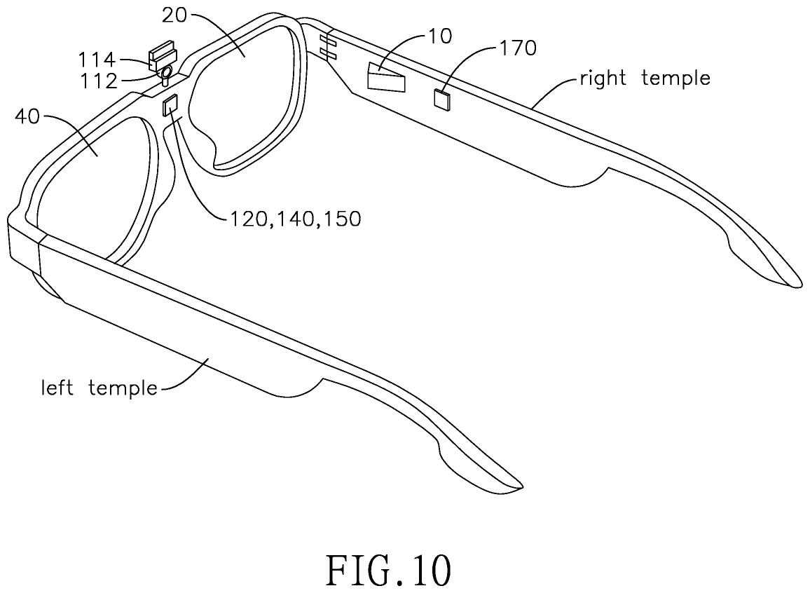

As shown in FIG. 10, the system 100 further includes a support structure that is wearable on a head of the user. The real object detection module 110, the real object recognition module 120, the virtual target object display module 130 (including a right light signal generator 10, a right combiner 20, a left light signal generator 30, and a left combiner 40), the collision module, and the interaction module are carried by the support structure. In one embodiment, the system is a head wearable device, such as a virtual reality (VR) goggle and a pair of augmented reality (AR)/mixed reality (MR) glasses. In this circumstance, the support structure may be a frame with or without lenses of the pair of glasses. The lenses may be prescription lenses used to correct nearsightedness, farsightedness, etc. In addition, the feedback module 160, the process module 170, the interface module 180, and the position module 116 may be also carried by the support structure.

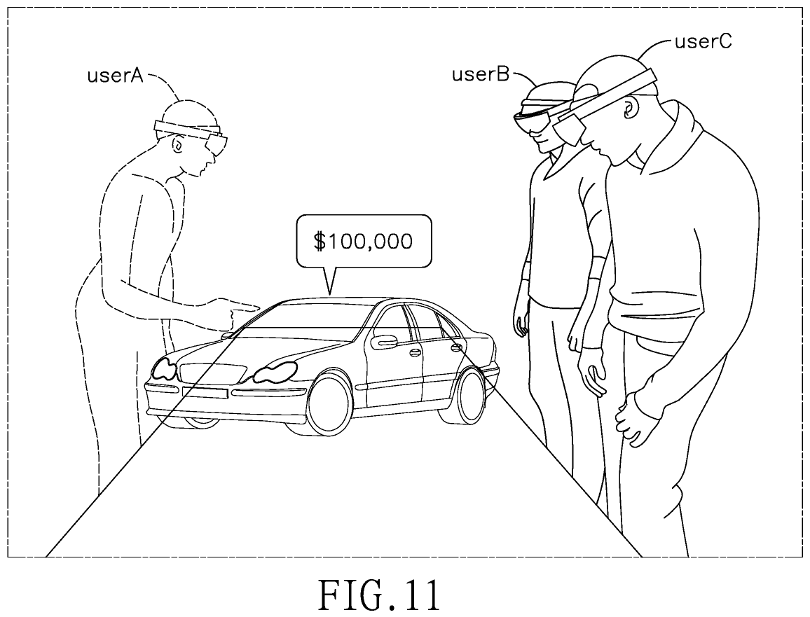

In an embodiment of the present invention, the system 100 may be utilized for the realization of multi-user interactions in unified AR/MR environments, such as remote meeting, remote learning, live broadcast, on-line auction, and remote shopping . . . etc. As a result, multiple users from different physical locations or same location may interact with each other via the AR/MR environment created by the system 100. FIG. 11 illustrates three users attend a remote meeting where user B and user C are at a conference room and user A joins the meeting remotely from other location. Each of the users may carry a set of system 100 in the form of a head wearable device such as a goggle and a pair of AR/MR glasses. As described above, each system 100 respectively comprises the real object detection module 110, the real object recognition module 120, the virtual object display module 130, the collision module 140, and the interaction module 150. Each system 100 may communicate with each other via various wired and/or wireless communication means to share various information, such as the relative position information of the users, the initiative objects, the target objects, and the video and audio information of the environment, as well as the individual user's events and their responding actions, so that multiple users may have about the same meeting experience. The position modules 116 may determine the positions of each of the users and the target real/virtual object in the real space and maps these positions in the AR environment having its own coordinate system. The information regarding the positions may be transmitted between the users for the respective virtual object display modules 130 to display the corresponding virtual objects to the users based upon different events and responding actions. The feedback modules 160 may also provide feedbacks, such as sounds and vibrations corresponding to the actions to the users.

In one example user B and user C are may see each other at the same conference room. Both user B and user C may see the virtual image of user A standing across the table in the meeting room through the virtual object display module 130 while user A is physically at his/her home. This function may be accomplished by a video system at user A's home taking his/her image and transmitting the image to the system worn by user B and user C so that user A's gestures and movements may be instantly observed. Alternatively, a pre-stored virtual image of user A may be displayed for user B and user C. User A may see the virtual image of user B and user C as well as the setup and environment of the conference room, which are taken by a video system in the conference room from the location the virtual user A stands in the conference room. Users A, B, and C may jointly interact with a virtual car (virtual target object). Each user an see the virtual car from his/her own view angle or one can select to see the virtual car from another's view angle with/without permission. When user A has control of the virtual car object, he/she can interact with virtual car object by for example opening a door and turning on a virtual DVD player inside the virtual car to play music so that all users can listen to the music. Only one person may have control of the whole virtual car or a separable part of the virtual car at a specific time.

Another example is that user A attends a car exhibition and stands next to a real car (real target object for user A). User B and user C may see a virtual car in the conference room from user A's view angle. Alternatively, user B and user C may see the virtual car from their own view angles if the information of the whole virtual car is available in the system. User A may interact with the real car, such as single tapping the real car to see a virtual car specification or double tapping the real car to see a virtual car price label. User B and user C may instantly see user A's tapping movements (events) and the virtual car specification and price label (actions) displayed by their virtual object display module. User B and user C may also interact with the virtual car remotely from the conference room. When user B has control of the virtual car, he/she may turn on a DVD player from a virtual car operation menu to cause the real car in the exhibition hall playing music and all users may hear the music from the feedback module. When the virtual price label is displayed, a user may single tap the virtual price label to convert the price into another type of currency for that user, or tap and slide the virtual price label to minimize or close it. The price label may exhibit a translational motion in the AR environments while being tapped and slid. Since the position of the virtual target object (i.e., the virtual price label) may be different from the perspective of each of the users, the position modules 116 may determine the corresponding positions for the respective virtual object display modules 130 to display the corresponding translational motion of the price tag for each of the users depending on their positions in the AR environment coordinate system.

The virtual object display module 130 and the method of generating virtual target objects 70 at predetermined locations and depths as well as the method of moving the virtual target objects as desired are discussed in details below. The PCT international application PCT/US20/59317, filed on Nov. 6, 2020, titled “SYSTEM AND METHOD FOR DISPLAYING AN OBJECT WITH DEPTHS” is incorporated herein by reference at its entirety.

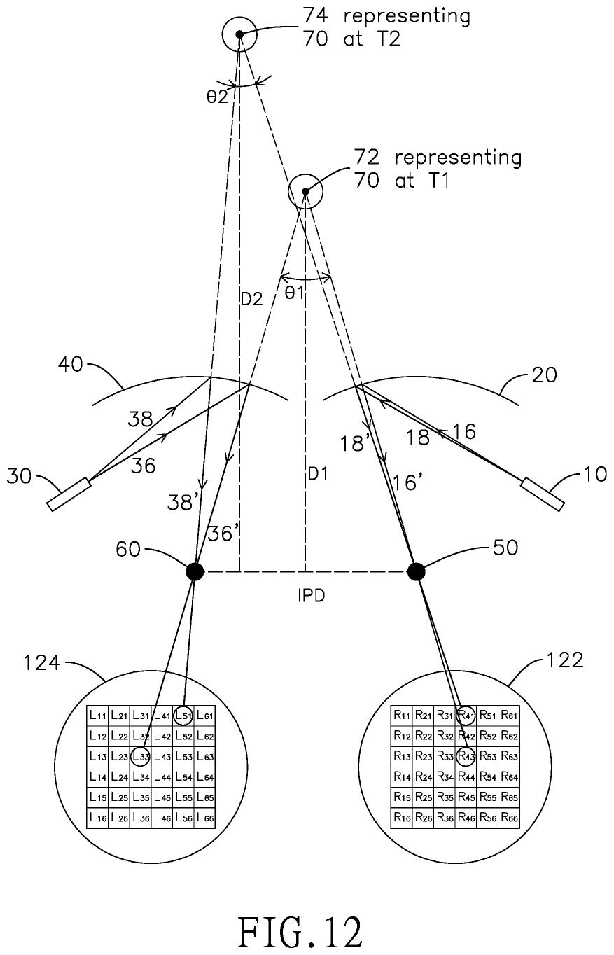

As shown in FIG. 12, the user perceives the virtual target object of the baseball 70 in the area C in front of the user. The virtual baseball target object 70 displayed at a first targeted position T1 (with depth D1) is represented a first virtual binocular pixel 72 (its center point) and when the virtual target object 70 moves to a second targeted position T2 (with depth D2), it is represented by the second virtual binocular pixel 74. The first angle between the first redirected right light signal 16′ (the first right light signal) and the corresponding first redirected left light signal (the first left light signal) 36′ is θ1. The first depth D1 is related to the first angle θ1. In particular, the first depth of the first virtual binocular pixel of the virtual target object 70 can be determined by the first angle θ1 between the light path extensions of the first redirected right light signal and the corresponding first redirected left light signal. As a result, the first depth D1 of the first virtual binocular pixel 72 can be calculated approximately by the following formula:

$$Tan ( \frac{θ}{2} ) = \frac{I P D}{2 D}$$

The distance between the right pupil 52 and the left pupil 62 is interpupillary distance (IPD). Similarly, the second angle between the second redirected right light signal (the second right light signal) 18′ and the corresponding second redirected left light signal (the second left light signal) 38′ is θ2. The second depth D2 is related to the second angle θ2. In particular, the second depth D2 of the second virtual binocular pixel 74 of the virtual target object 70 at T2 can be determined approximately by the second angle θ2 between the light path extensions of the second redirected right light signal and the corresponding second redirected left light signal by the same formula. Since the second virtual binocular pixel 74 is perceived by the user to be further away from the user (i.e. with larger depth) than the first virtual binocular pixel 72, the second angle θ2 is smaller than the first angle θ1.

Furthermore, although the redirected right light signal 16′ for RLS_2 and the corresponding redirected left light signal 36′ for LLS_2 together display a first virtual binocular pixel 72 with the first depth D1. The redirected right light signal 16′ for RLS_2 may present an image of the same or different view angle from the corresponding redirected left light signal 36′ for LLS_2. In other words, although the first angle θ1 determines the depth of the first virtual binocular pixel 72, the redirected right light signal 16′ for RLS_2 may be or may not be a parallax of the corresponding redirected left light signal 36′ for LLS_2. Thus, the intensity of red, blue, and green (RBG) color and/or the brightness of the right light signal and the left light signal may be approximately the same or slightly different, because of the shades, view angle, and so forth, to better present some 3D effects.

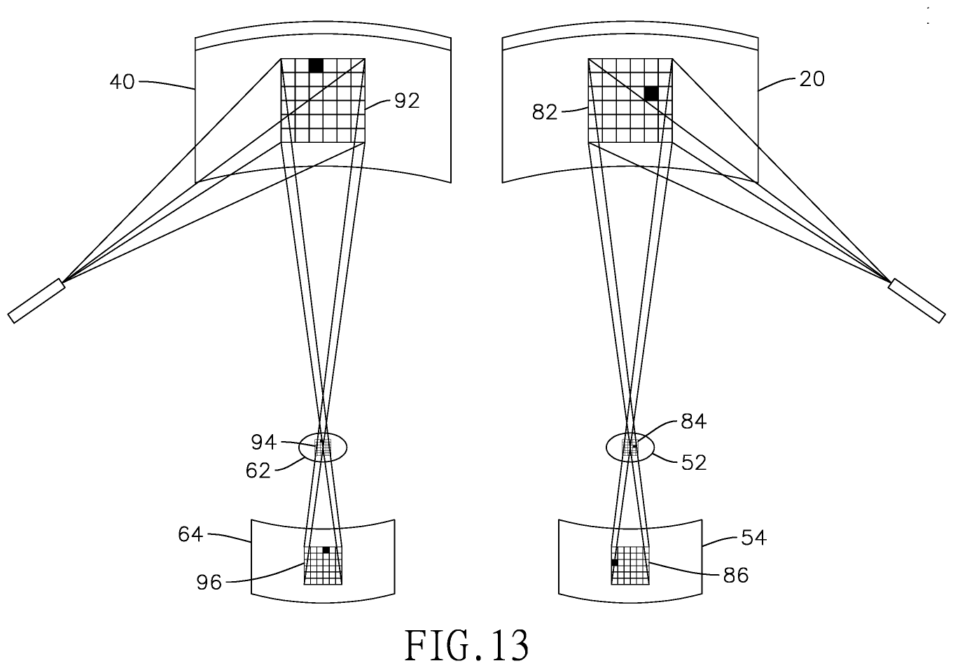

As described above, the multiple right light signals are generated by the right light signal generator 10, redirected by the right combiner 20, and then directly scanned onto the right retina to form a right image 122 (right retina image 86 in FIG. 13) on the right retina. Likewise, the multiple left light signals are generated by left light signal generator 30, redirected by the left combiner 40, and then scanned onto the left retina to form a left image 124 (left retina image 96 in FIG. 13) on the left retina. In an embodiment shown in FIG. 12, a right image 122 contains 36 right pixels in a 6×6 array and a left image 124 also contains 36 left pixels in a 6×6 array. In another embodiment, a right image 122 may contain 921,600 right pixels in a 1280×720 array and a left image 124 may also contain 921,600 left pixels in a 1280×720 array. The virtual object display module 130 is configured to generate multiple right light signals and corresponding multiple left light signals which respectively form the right image 122 on the right retina and left image 124 on the left retina. As a result, the user perceives a virtual target object with specific depths in the area C because of image fusion.

With reference to FIG. 12, the first right light signal 16 from the right light signal generator 10 is received and reflected by the right combiner 20. The first redirected right light signal 16′, through the right pupil 52, arrives the right retina of the user to display the right retina pixel R43. The corresponding left light signal 36 from the left light signal generator 30 is received and reflected by the left combiner 40. The first redirected light signal 36′, through the left pupil 62, arrives the left retina of the user to display the left retina pixel L33. As a result of image fusion, a user perceives the virtual target object 70 at the first depth D1 determined by the first angle of the first redirected right light signal and the corresponding first redirected left light signal. The angle between a redirected right light signal and a corresponding left light signal is determined by the relative horizontal distance of the right pixel and the left pixel. Thus, the depth of a virtual binocular pixel is inversely correlated to the relative horizontal distance between the right pixel and the corresponding left pixel forming the virtual binocular pixel. In other words, the deeper a virtual binocular pixel is perceived by the user, the smaller the relative horizontal distance at X axis between the right pixel and left pixel forming such a virtual binocular pixel is. For example, as shown in FIG. 12, the second virtual binocular pixel 74 is perceived by the user to have a larger depth (i.e. further away from the user) than the first virtual binocular pixel 72. Thus, the horizontal distance between the second right pixel and the second left pixel is smaller than the horizontal distance between the first right pixel and the first left pixel on the retina images 122, 124. Specifically, the horizontal distance between the second right pixel R41 and the second left pixel L51 forming the second virtual binocular pixel 74 is four-pixel long. However, the distance between the first right pixel R43 and the first left pixel L33 forming the first virtual binocular pixel 72 is six-pixel long.

In one embodiment shown in FIG. 13, the light paths of multiple right light signals and multiple left light signals from light signal generators to retinas are illustrated. The multiple right light signals generated from the right light signal generator 10 are projected onto the right combiner 20 to form a right combiner image (RSI) 82. These multiple right light signals are redirected by the right combiner 20 and converge into a small right pupil image (RPI) 84 to pass through the right pupil 52, and then eventually arrive the right retina 54 to form a right retina image (RRI) 86 (right image 122). Each of the RSI, RPI, and RRI comprises i×j pixels. Each right light signal RLS(i,j) travels through the same corresponding pixels from RSI(i,j), to RPI(i,j), and then to RRI(x,y). For example RLS(5,3) travels from RSI(5,3), to RPI(5,3) and then to RRI(2,4). Likewise, the multiple left light signals generated from the left light signal generator 30 are projected onto the left combiner 40 to form a left combiner image (LSI) 92. These multiple left light signals are redirected by the left combiner 40 and converge into a small left pupil image (LPI) 94 to pass through the left pupil 62, and then eventually arrive the left retina 64 to form an left retina image (LRI) 96 (left image 124). Each of the LSI, LPI, and LRI comprises i×j pixels. Each left light signal ALS(i,j) travels through the same corresponding pixels from LCI(i,j), to LPI(i,j), and then to LRI(x,y). For example ALS(3,1) travels from LCI(3,1), to LPI(3,1) and then to LRI(4,6). The (0, 0) pixel is the top and left most pixel of each image. Pixels in the retina image is left-right inverted and top-bottom inverted to the corresponding pixels in the combiner image. Based on appropriate arrangements of the relative positions and angles of the light signal generators and combiners, each light signal has its own light path from a light signal generator to a retina. The combination of one right light signal displaying one right pixel on the right retina and one corresponding left light signal displaying one left pixel on the left retina forms a virtual binocular pixel with a specific depth perceived by a user. Thus, a virtual binocular pixel in the space can be represented by a pair of right retina pixel and left retina pixel or a pair of right combiner pixel and left combiner pixel.

A virtual target object perceived by a user in area C may include multiple virtual binocular pixels but is represented by one virtual binocular pixel in this disclosure. To precisely describe the location of a virtual binocular pixel in the space, each location in the space is provided a three dimensional (3D) coordinate, for example XYZ coordinate. Other 3D coordinate system can be used in another embodiment. As a result, each virtual binocular pixel has a 3D coordinate—a horizontal direction, a vertical direction, and a depth direction. A horizontal direction (or X axis direction) is along the direction of interpupillary line. A vertical direction (or Y axis direction) is along the facial midline and perpendicular to the horizontal direction. A depth direction (or Z axis direction) is right to the frontal plane and perpendicular to both the horizontal and vertical directions. The horizontal direction coordinate and vertical direction coordinate are collectively referred to as the location in the present invention.

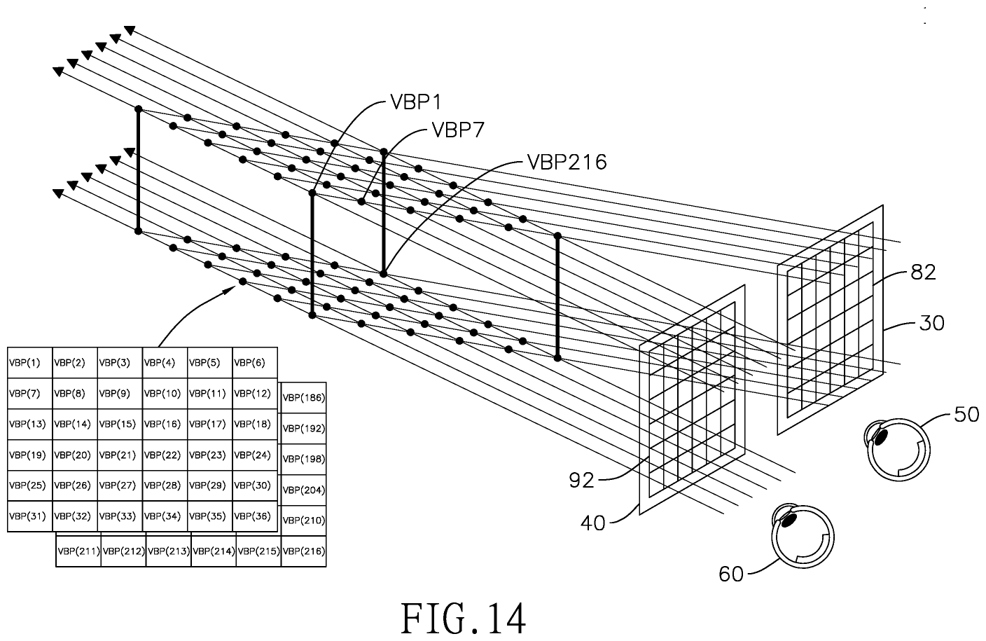

FIG. 14 illustrates the relationship between pixels in the right combiner image, pixels in the left combiner image, and the virtual binocular pixels. As described above, pixels in the right combiner image are one to one correspondence to pixels in the right retina image (right pixels). Pixels in the left combiner image are one to one correspondence to pixels in the left retina image (left pixels). However, pixels in the retina image is left-right inverted and top-bottom inverted to the corresponding pixels in the combiner image. For a right retina image comprising 36 (6×6) right pixels and an left retina image comprising 36 (6×6) left pixels, there are 216 (6×6×6) virtual binocular pixels (shown as a dot) in the area C assuming all light signals are within FOV of both eyes of the user. The light path extension of one redirected right light signal intersects the light path extension of each redirected left light signal on the same row of the image. Likewise, the light path extension of one redirected left light signal intersects the light path extension of each redirected right light signal on the same row of the image. Thus, there are 36 (6×6) virtual binocular pixels on one layer and 6 layers in the space. There is usually a small angle between two adjacent lines representing light path extensions to intersect and form virtual binocular pixels although they are shown as parallel lines in the FIG. 14. A right pixel and a corresponding left pixel at approximately the same height of each retina (i.e. the same row of the right retina image and left retina image) tend to fuse earlier. As a result, right pixels are paired with left pixels at the same row of the retina image to form virtual binocular pixels.

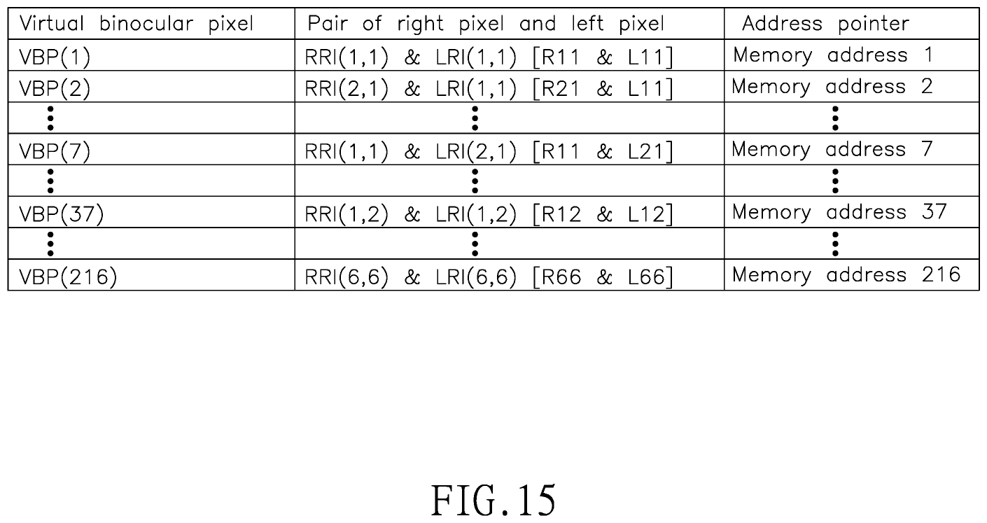

As shown in FIG. 15, a look-up table is created to facilitate identifying the right pixel and left pixel pair for each virtual binocular pixel. For example, 216 virtual binocular pixels, numbering from 1 to 216, are formed by 36 (6×6) right pixels and 36 (6×6) left pixels. The first (1^{st}) virtual binocular pixel VBP(1) represents the pair of right pixel RRI(1,1) and left pixel LRI(1,1). The second (2^{nd}) virtual binocular pixel VBP(2) represents the pair of right pixel RRI(2,1) and left pixel LRI(1,1). The seventh (7^{th}) virtual binocular pixel VBP(7) represents the pair of right pixel RRI(1,1) and left pixel LRI(2,1). The thirty-seventh (37^{th}) virtual binocular pixel VBP(37) represents the pair of right pixel RRI(1,2) and left pixel LRI(1,2). The two hundred and sixteenth (216′) virtual binocular pixel VBP(216) represents the pair of right pixel RRI(6,6) and left pixel LRI(6,6). Thus, in order to display a specific virtual binocular pixel of a virtual target object in the space for the user, it is determined which pair of the right pixel and left pixel can be used for generating the corresponding right light signal and left light signal. In addition, each row of a virtual binocular pixel on the look-up table includes a pointer which leads to a memory address that stores the perceived depth (z) of the VBP and the perceived position (x,y) of the VBP. Additional information, such as scale of size, number of overlapping objects, and depth in sequence depth etc., can also be stored for the VBP. Scale of size may be the relative size information of a specific VBP compared against a standard VBP. For example, the scale of size may be set to be 1 when the virtual target object is displayed at a standard VBP that is 1 m in front of the user. As a result, the scale of size may be set to be 1.2 for a specific VBP that is 90 cm in front of the user. Likewise, when the scale of size may be set to be 0.8 for a specific VBP that is 1.5 m in front of the user. The scale of size can be used to determine the size of the virtual target object for displaying when the virtual target object is moved from a first depth to a second depth. Scale of size may be the magnification in the present invention. The number of overlapping objects is the number of objects that are overlapped with one another so that one object is completely or partially hidden behind another object. The depth in sequence provides information about sequence of depths of various overlapping images. For example, 3 images overlapping with each other. The depth in sequence of the first image in the front may be set to be 1 and the depth in sequence of the second image hidden behind the first image may be set to be 2. The number of overlapping images and the depth in sequence may be used to determine which and what portion of the images need to be displayed when various overlapping images are in moving.

The look up table may be created by the following processes. At the first step, obtain an individual virtual map based on his/her IPD, created by the virtual object display module during initiation or calibration, which specify the boundary of the area C where the user can perceive a virtual target object with depths because of the fusion of right retina image and left retina image. At the second step, for each depth at Z axis direction (each point at Z-coordinate), calculate the convergence angle to identify the pair of right pixel and left pixel respectively on the right retina image and the left retina image regardless of the X-coordinate and Y-coordinate location. At the third step, move the pair of right pixel and left pixel along X axis direction to identify the X-coordinate and Z-coordinate of each pair of right pixel and left pixel at a specific depth regardless of the Y-coordinate location. At the fourth step, move the pair of right pixel and left pixel along Y axis direction to determine the Y-coordinate of each pair of right pixel and left pixel. As a result, the 3D coordinate system such as XYZ of each pair of right pixel and left pixel respectively on the right retina image and the left retina image can be determined to create the look up table. In addition, the third step and the fourth step are exchangeable.

The light signal generator 10 and 30 may use laser, light emitting diode (“LED”) including mini and micro LED, organic light emitting diode (“OLED”), or superluminescent diode (“SLD”), LCoS (Liquid Crystal on Silicon), liquid crystal display (“LCD”), or any combination thereof as its light source. In one embodiment, the light signal generator 10 and 30 is a laser beam scanning projector (LBS projector) which may comprise the light source including a red color light laser, a green color light laser, and a blue color light laser, a light color modifier, such as Dichroic combiner and Polarizing combiner, and a two dimensional (2D) adjustable reflector, such as a 2D electromechanical system (“MEMS”) mirror. The 2D adjustable reflector can be replaced by two one dimensional (1D) reflector, such as two 1D MEMS mirror. The LBS projector sequentially generates and scans light signals one by one to form a 2D image at a predetermined resolution, for example 1280×720 pixels per frame. Thus, one light signal for one pixel is generated and projected at a time towards the combiner 20, 40. For a user to see such a 2D image from one eye, the LBS projector has to sequentially generate light signals for each pixel, for example 1280×720 light signals, within the time period of persistence of vision, for example 1/18 second. Thus, the time duration of each light signal is about 60.28 nanosecond.

In another embodiment, the light signal generator 10 and 30 may be a digital light processing projector (“DLP projector”) which can generate a 2D color image at one time. Texas Instrument's DLP technology is one of several technologies that can be used to manufacture the DLP projector. The whole 2D color image frame, which for example may comprise 1280×720 pixels, is simultaneously projected towards the combiners 20, 40.

The combiner 20, 40 receives and redirects multiple light signals generated by the light signal generator 10, 30. In one embodiment, the combiner 20, 40 reflects the multiple light signals so that the redirected light signals are on the same side of the combiner 20, 40 as the incident light signals. In another embodiment, the combiner 20, 40 refracts the multiple light signals so that the redirected light signals are on the different side of the combiner 20, 40 from the incident light signals. When the combiner 20, 40 functions as a refractor. The reflection ratio can vary widely, such as 20%-80%, in part depending on the power of the light signal generator. People with ordinary skill in the art know how to determine the appropriate reflection ratio based on characteristics of the light signal generators and the combiners. Besides, in one embodiment, the combiner 20, 40 is optically transparent to the ambient (environmental) lights from the opposite side of the incident light signals so that the user can observe the real-time image at the same time. The degree of transparency can vary widely depending on the application. For AR/MR application, the transparency is preferred to be more than 50%, such as about 75% in one embodiment.

The combiner 20, 40 may be made of glasses or plastic materials like lens, coated with certain materials such as metals to make it partially transparent and partially reflective. One advantage of using a reflective combiner instead of a wave guide in the prior art for directing light signals to the user's eyes is to eliminate the problem of undesirable diffraction effects, such as multiple shadows, color displacement . . . etc.

The present disclosure also includes a system for real object recognition. The system includes a real object detection module, a real object recognition module, and an interaction module. The real object detection module is configured to receive multiple image pixels and the corresponding depths of at least one of a right hand and a left hand. The real object recognition module is configured to determine a shape, a position, and a movement of the at least one of the right hand and the left hand. The interaction module is configured to determine an action responding to an event based on an object recognition determination from the real object recognition module. In addition, the real object recognition module determines the position of at least one of the right hand and the left hand by identifying at least 17 feature points respectively for the hand and obtaining a 3D coordinate for each feature point. Furthermore, the real object recognition module determines the shape of at least one of the right hand and the left hand by determining whether each finger is respectively curved or straight. The descriptions above with respect to the real object detection module, the real object recognition module, the interaction module, and other modules apply in this system for real object recognition.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A system for object interactions, comprising:
a real object detection module to receive multiple image pixels and the corresponding depths of at least one of a first initiative object and a second initiative object;
a real object recognition module to determine a shape, a position, and a movement of the at least one of the first initiative object and the second initiative object;
a virtual target object display module to display a virtual target object at a first depth by projecting multiple right light signals towards one retina of a user and multiple left light signals towards the other retina of the user, wherein the first depth is related to a first angle between the right light signal and the corresponding left light signal projected into the user's retinas;
a collision module to determine whether at least one of the first initiative object and the second initiative object collides into a virtual target object and, if a collision occurs, a collision region, and a collision time; and
an interaction module to determine an action responding to an event based on at least one of an object recognition determination from the real object recognition module, a collision determination from the collision module, and a type of the virtual target object.

2. The system of claim 1, wherein the real object detection module comprises at least one RGB camera to receive multiple image pixels of at least one of the first initiative object and the second initiative object, and at least one depth camera to receive the corresponding depths.

3. The system of claim 1, wherein the real object recognition module employs the multiple image pixels and their corresponding depths captured at the same time to adjust horizontal coordinates and vertical coordinates for at least one of the first initiative object and the second initiative object.

4. The system of claim 3, wherein if the first initiative object is a right hand and the second initiative object is a left hand, the real object recognition module identifies at least 17 feature points respectively for at least one of the right hand and the left hand, and obtains a 3D coordinate for each feature point.

5. The system of claim 1, wherein if the first initiative object is a right hand and the second initiative object is a left hand, the real object recognition module determines the shape of at least one of the right hand and the left hand by determining whether each finger is respectively curved or straight.

6. The system of claim 5, wherein each hand has a wrist feature point, each finger has a first joint, a second joint, and a fingertip, and a finger is determined to be straight when a finger angle between a first line formed by a wrist feature point and a first joint of the finger and a second line formed by the first joint and a fingertip of the finger is larger than a predetermined angle.

7. The system of claim 6, wherein for an index finger, a middle finger, a ring finger, and a little finger, the finger is determined to be straight when a finger length difference between a first length measuring from the waist feature point to the second joint of the finger and a second length measuring from the waist feature point and the fingertip of the finger is larger than a predetermined length, and for a thumb, the thumb is determined to be straight when a finger length difference between a third length measuring from a thumb tip to a first joint of the little finger and a fourth length measuring from a second joint of the thumb to the first joint of the little finger is larger than a predetermined length.

8. The system of claim 7, wherein the finger is determined to be straight when both the finger angle is larger than approximately 120 degrees and the finger length difference is large than approximately zero.

9. The system of claim 1, wherein the real object recognition module determines the movement of at least one of the first initiative object and the second initiative object by changes of the shape and the position of at least one of the first initiative object and the second initiative object during a predetermined time period.

10. The system of claim 9, wherein the real object recognition module determines a speed or an acceleration of the movement by changes of the position of at least one of the first initiative object and the second initiative object during a predetermined time period.

11. The system of claim 1, wherein if the first initiative object is a right hand and the second initiative object is a left hand, the collision module generates an outer surface simulation for at least one of the right hand and the left hand.

12. The system of claim 11, wherein the outer surface simulation is an assembly of multiple 3D convex components, which represents the shape of the right hand or the left hand.

13. The system of claim 12, wherein each of the multiple 3D convex component comprises one of cylinders, prisms, spheres, pyramids, cuboids, cubes, and solid triangles.

14. The system of claim 11, wherein the collision module determines that a collision occurs, if there is a contact between the outer surface simulation for at least one of the right hand and the left hand and an outer surface of the virtual target object.

15. The system of claim 14, wherein there is a contact between the outer surface simulation for at least one of the right hand and the left hand and an outer surface of the virtual target object, if (1) the outer surface simulation for at least one of the right hand and the left hand intersects with an outer surface of the virtual target object or (2) a smallest distance between the outer surface simulation for at least one of the right hand and the left hand and an outer surface of the virtual target object is less than a predetermined distance.

16. The system of claim 15, wherein the collision module determines a collision type by a number of contacts, the collision region of each contact, and the collision time of each contact.

17. The system of claim 16, wherein the virtual target object may be one of at least two types comprising a movable target object and a fixed target object.

18. The system of claim 17, wherein when the virtual target object is a fixed user interface object and the collision determination is that a collision occurs, the interaction module determines the action based on a description of the fixed user interface object.

19. The system of claim 17, wherein the collision determination is “pushing” if the number of contact is one or more, and the collision time is shorter than a predetermined time period.

20. The system of claim 19, wherein when the virtual target object is a movable target object, the collision determination is “pushing,” and the object recognition determination is that the movement of a pushing hand has a speed faster than a predetermined speed, the interaction module determines a reacting movement for the virtual target object, and the virtual object display module displays the virtual target object in the reacting movement.

21. The system of claim 16, wherein the collision determination is “holding,” if the number of contacts is two or more, the at least two collision regions are fingertips, and the collision time is longer than a predetermined time period.

22. The system of claim 21, wherein when the virtual target object is a movable target object, the collision determination is “holding,” and the object recognition determination is that the movement of a holding hand has a speed slower than a predetermined speed, the interaction module determines a reacting movement for the virtual target object, which corresponds to the movement of the holding hand, and the virtual object display module displays the virtual target object in the reacting movement.

23. The system of claim 1, further comprising:
a feedback module configured to provide a feedback to the user when the collision is occurred.

24. The system of claim 1, wherein the virtual target object display module further comprises
a right light signal generator generating the multiple right light signals to form a right image;
a right combiner redirecting the multiple right light signals towards one retina of the user;
a left signal generator generating the multiple left light signals to form a left image; and
a left combiner redirecting the multiple left light signals towards the other retina of the user.

25. The system of claim 1, further comprising:
a support structure wearable on a head of the user;
wherein the real object detection module, the real object recognition module, the virtual target object display module, the collision module, and the interaction module are carried by the support structure.

26. A system for real object recognition, comprising:
a real object detection module to receive multiple image pixels and the corresponding depths of at least one of a right hand and a left hand;
a real object recognition module to determine a shape, a position, and a movement of the at least one of the right hand and the left hand;
a interaction module to determine an action responding to an event based on an object recognition determination from the real object recognition module;
wherein the real object recognition module determines the position of at least one of the right hand and the left hand by identifying at least 17 feature points respectively for the hand and obtaining a 3D coordinate for each feature point; and
wherein the real object recognition module determines the shape of at least one of the right hand and the left hand by determining whether each finger is respectively curved or straight.

27. The system of claim 26, wherein the real object detection module comprises at least one RGB camera to receive multiple image pixels of at least one of the right hand and the left hand, and at least one depth camera to receive the corresponding depths.

28. The system of claim 26, wherein the real object recognition module employs the multiple image pixels and their corresponding depths captured at the same time to adjust horizontal coordinates and vertical coordinates respectively for at least one of the right hand and the left hand.

29. The system of claim 26, wherein each hand has a wrist feature point, each finger has a first joint, a second joint, and a fingertip, and a finger is determined to be straight when a finger angle between a first line formed by a wrist feature point and a first joint of the finger and a second line formed by the first joint and a fingertip of the finger is larger than a predetermined angle.

30. The system of claim 29, wherein for an index finger, a middle finger, a ring finger, and a little finger, the finger is determined to be straight when a finger length difference between a first length measuring from the waist feature point to the second joint of the finger and a second length measuring from the waist feature point and the fingertip of the finger is larger than a predetermined length, and for a thumb, the thumb is determined to be straight when a finger length difference between a third length measuring from a thumb tip to a first joint of the little finger and a fourth length measuring from a second joint of the thumb to the first joint of the little finger is larger than a predetermined length.

31. The system of claim 30, wherein the finger is determined to be straight when both the finger angle is larger than approximately 120 degrees and the finger length difference is large than approximately zero.

32. The system of claim 26, wherein the real object recognition module determines the movement of at least one of the right hand and the left hand by changes of the shape and the position of at least one of the first initiative object and the second object during a predetermined time period.

33. The system of claim 26, wherein the real object recognition module determines a speed or an acceleration of the movement by changes of the position of at least one of the right hand and the left hand during a predetermined time period.
